(19) United States
(12) Patent Application Publication
(10) Pub. No.: US 2004/0051506 A1
(43) Pub. Date: Mar. 18, 2004

(54) Bicycle power supply with full-wave and half-wave charging elements

(75) Inventor: Satoshi Kitamura, Kitakatsuragi-gun (JP)

Correspondence Address: DELAND LAW OFFICE, P.O. BOX 69, KLAMATH RIVER, CA, 96050-0069, US

(73) Assignee: Shimano, Inc.

(21) Appl. No.: 10/616,252

(22) Filed: Jul. 8, 2003

(30) Foreign Application Priority Data
Jul. 11, 2002 (JP) 2002-202501

(51) Int. Cl. H02J 7/00

(52) U.S. Cl. 320/137

(57) ABSTRACT

A charging apparatus comprises a rectifying circuit for rectifying the alternating current from the bicycle dynamo; a full-wave charging element operatively coupled to the rectifying circuit for charging during both positive and negative half-cycles of the bicycle dynamo; a first half-wave charging element operatively coupled to the rectifying circuit in parallel with the full-wave charging element, wherein the first half-wave charging element charges during positive half-cycles of said dynamo; and a second half-wave charging element operatively coupled to the rectifying circuit in parallel with the full-wave charging element, wherein the second half-wave charging element charges during negative half-cycles of the dynamo.

### BACKGROUND OF THE INVENTION

The present invention is directed to bicycles and, more particularly, to a charging apparatus that charges with voltage from an alternating current bicycle dynamo.

Automatic transmission shifting devices are commonly provided in newer bicycles. Such bicycles often employ an electrically powered transmission. Accordingly, a dynamo is usually provided for generating electrical power, and a charging system is provided for charging a battery or other voltage storing device used to supply the electrical power to the electrically powered transmission. Since the dynamo generates an alternating current voltage, and since electrically powered transmissions often operate using direct current voltages, half-wave or full-wave rectification of the dynamo output signal usually must be performed.

Voltage generated by the bicycle dynamo increases or decreases depending on bicycle speed, and low voltages typically accompany low speed operation. As a result, electrical devices often cannot be provided with sufficient voltage during low speed operation, thus possibly resulting in malfunction of the devices. This problem could be addressed by expanding the charging capacitor so that the devices would be supplied with adequate voltage even at low speed. However, electric double layer capacitors commonly employed as charging capacitors in such applications are expensive, thus leading to increased cost of the overall system.

### SUMMARY OF THE INVENTION

The present invention is directed to various features of a charging apparatus that charges with voltage from an alternating current bicycle dynamo. In one embodiment, a charging apparatus comprises a rectifying circuit for rectifying the alternating current from the bicycle dynamo; a full-wave charging element operatively coupled to the rectifying circuit for charging during both positive and negative half-cycles of the bicycle dynamo; a first half-wave charging element operatively coupled to the rectifying circuit in parallel with the full-wave charging element, wherein the first half-wave charging element charges during positive half-cycles of said dynamo; and a second half-wave charging element operatively coupled to the rectifying circuit in parallel with the full-wave charging element, wherein the second half-wave charging element charges during negative half-cycles of the dynamo. Additional inventive features will become apparent from the description below, and such features alone or in combination with the above features may form the basis of further inventions as recited in the claims and their equivalents.

### BRIEF DESCRIPTION OF THE DRAWINGS

FIG. 1 is a schematic diagram of a particular embodiment of a charging apparatus that charges with voltage from an alternating current bicycle dynamo;

FIG. 2 is a schematic diagram showing the operation of the charging apparatus during a positive half-cycle of the bicycle dynamo; and

FIG. 3 is a schematic diagram showing the operation of the charging apparatus during a negative half-cycle of the bicycle dynamo.

### DETAILED DESCRIPTION OF THE EMBODIMENTS

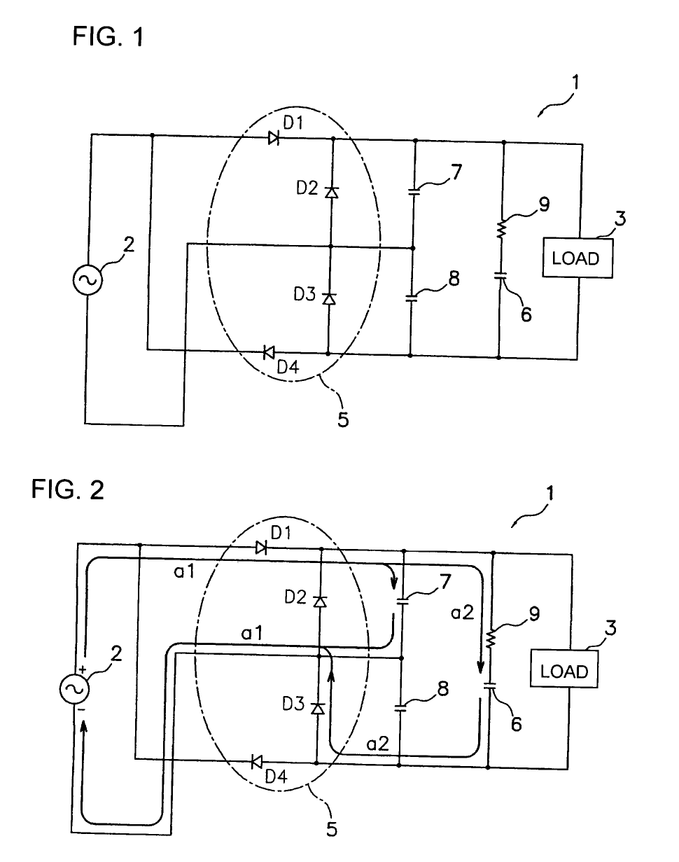

FIG. 1 is a schematic diagram of a particular embodiment of a charging apparatus 1 that charges with voltage from an alternating current bicycle dynamo 2, wherein charging apparatus 1 is connected between dynamo 2 and a load 3. Charging apparatus 1 comprises a full-wave rectifier circuit 5, a full-wave charging element comprising an electric double layer capacitor 6 (which is environmentally friendly), and first and second half-wave charging elements comprising first and second electrolytic capacitors 7 and 8. A resistance 9 is connected in series with electric double layer capacitor 6.

In this embodiment, full-wave rectifier circuit 5 is a bridge rectifier circuit comprising four connected diodes D1, D2, D3, D4. Electric double layer capacitor 6 is connected to the output of full-wave rectifier circuit 5 such that full-wave rectifier circuit 5 charges electric double layer capacitor 6 during the entire sinusoidal cycle of dynamo 2. First and second electrolytic capacitors 7 and 8 are connected in parallel with electric double layer capacitor 6. More specifically, one end of first electrolytic capacitor 7 and the terminal of resistor 9 opposite electric double layer capacitor 6 are connected to a node between diode D1 and diode D2 of full-wave rectifier circuit 5, and at the other end of first electrolytic capacitor 7 is connected to a node between diode D2 and diode D3. One end of second electrolytic capacitor 8 is connected to the node between diode D2 and diode D3, and the other end of second electrolytic capacitor 8 together with the terminal of electric double layer capacitor 6 opposite resistor 9 are connected to a node between diode D3 and diode D4.

During the operation of the bicycle, AC voltage is output from dynamo 2 when dynamo 2 rotates together with the bicycle wheels. During the positive half-cycle of the AC voltage shown in FIG. 2 (when a positive signal is applied to diode D1), electrical current output from a first terminal of dynamo 2 passes through diode D1, through first electrolytic capacitor 7, and to the second terminal of dynamo 2 as shown by path al. At the same time, current having passed through diode D1 passes through resistance 9 and electric double layer capacitor 6, then passes through diode D3 and to the second terminal of dynamo 2 as shown by path a2 in FIG. 2. The electric double layer capacitor 6 is charged during this time.

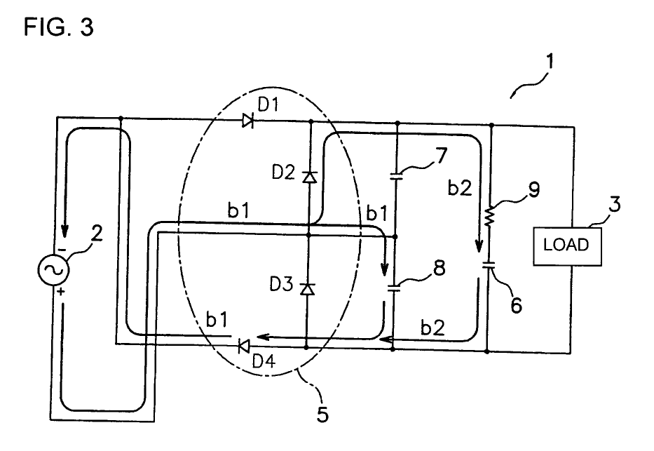

When polarity subsequently reverses during the negative half-cycle of the AC voltage shown in FIG. 3, current output from the second terminal of dynamo 2 passes through second electrolytic capacitor 8, through diode D4 and to the first terminal of dynamo 2 as shown by path b 1. The second electrolytic capacitor 8 is charged during this time. At the same time, current having passed through diode D2 passes through resistance 9 and electric double layer capacitor 6, then passes through diode D4 and to the first terminal of dynamo 2 as shown by path b2 in FIG. 3. The electric double layer capacitor 6 is charged during this time. In this negative half-cycle, potential rises at the negative side of first electrolytic capacitor 7, and the charge with which first electrolytic capacitor 7 has been charged flows into electric double layer capacitor 6. As a result, electric double layer capacitor 6 is charged with voltage equal to or greater than the voltage generated by the dynamo 2.

Capacitors 6, 7, and 8 are repeatedly charged by the above-described operation. Electric double layer capacitor 8 is charged to voltage that is double the peak value of the maximum dynamo voltage, thus eliminating the problem of insufficient voltage at low speed (i.e., during low dynamo rotation speed). Additionally, the first and second electrolytic capacitors 7 and 8 are relatively inexpensive, so increased cost of the devices can be avoided.

While the above is a description of various embodiments of inventive features, further modifications may be employed without departing from the spirit and scope of the present invention. For example, while an electric double layer capacitor was used as the full-wave charging element in the described embodiment, a different element such as a secondary cell could be used instead. Such a secondary cell further decreases the cost of the device. The size, shape, location or orientation of the various components may be changed as desired. Components that are shown directly connected or contacting each other may have intermediate structures disposed between them. The functions of one element may be performed by two, and vice versa. The structures and functions of one embodiment may be adopted in another embodiment. It is not necessary for all advantages to be present in a particular embodiment at the same time. Every feature that is unique from the prior art, alone or in combination with other features, also should be considered a separate description of further inventions by the applicant, including the structural and/or functional concepts embodied by such feature(s). Thus, the scope of the invention should not be limited by the specific structures disclosed or the apparent initial focus or emphasis on a particular structure or feature.

What is claimed is:

1. A charging apparatus that charges with voltage from an alternating current bicycle dynamo, wherein the charging apparatus comprises:
a rectifying circuit for rectifying the alternating current from the bicycle dynamo;
a full-wave charging element operatively coupled to the rectifying circuit for charging during both positive and negative half-cycles of the bicycle dynamo;
a first half-wave charging element operatively coupled to the rectifying circuit in parallel with the full-wave charging element, wherein the first half-wave charging element charges during positive half-cycles of said dynamo; and
a second half-wave charging element operatively coupled to the rectifying circuit in parallel with the full-wave charging element, wherein the second half-wave charging element charges during negative half-cycles of the dynamo.

2. The charging apparatus according to claim 1 wherein the full-wave charging element comprises a secondary cell.

3. The charging apparatus according to claim 1 wherein the first half-wave charging element is connected in series with the second half-wave charging element.

4. The charging apparatus according to claim 1 wherein the full-wave charging element comprises an electric double layer capacitor.

5. The charging apparatus according to claim 4 wherein the first half-wave charging element comprises a first electrolytic capacitor.

6. The charging apparatus according to claim 5 wherein the second half-wave charging element comprises a second electrolytic capacitor.

7. The charging apparatus according to claim 6 wherein the first electrolytic capacitor is connected in series with the second electrolytic capacitor.

8. The charging apparatus according to claim 1 wherein the first half-wave charging element comprises a first electrolytic capacitor.

9. The charging apparatus according to claim 8 wherein the second half-wave charging element comprises a second electrolytic capacitor.

10. The charging apparatus according to claim 9 wherein the first electrolytic capacitor is connected in series with the second electrolytic capacitor.
